(19) United States
(12) Patent Application Publication
(10) Pub. No.: US 2024/0025099 A1
(43) Pub. Date: Jan. 25, 2024

(54) Injection Molding System and Method with Task Based User Interface

(71) Applicant: Barnes Group, Inc., Bristol, CT (US)

(72) Inventors: Sergio Ribeiro de Oliveira Antunes, Amesbury, MA (US); Margaret Jacobi, Peabody, MA (US); Sandra Quinn, Newburyport, MA (US); Corey Dinopoulos, South Boston, MA (US)

(21) Appl. No.: 18/369,888

(22) Filed: Sep. 19, 2023

Related U.S. Application Data
(63) Continuation of application No. PCT/US2022/021874, filed on Mar. 25, 2022.
(60) Provisional application No. 63/166,036, filed on Mar. 25, 2021.

(51) Int. Cl. B29C 45/77; B29C 45/78; B29C 45/23; B29C 45/28; B29C 45/17; B29C 45/76

(52) U.S. Cl. CPC B29C 45/77; B29C 45/78; B29C 45/23; B29C 45/2806; B29C 45/1774; B29C 45/762; B29C 2045/7606; B29C 2945/76498; B29C 2945/76531; B29C 2945/76993; B29C 2945/76752; B29C 2945/76688; B29C 2945/76735; B29C 2945/76648; B29C 2945/76939

(57) ABSTRACT

An injection molding task based navigation system for a computer user interface, wherein the navigation system automatically presents the user with a set of tasks that can be performed based on the system state(s) of the injection molding apparatus, the user class (e.g., level or credentials) and the device by which the user has gained access to the navigation system.

### FIELD OF THE INVENTION

The present invention relates to injection molding systems, and more specifically to a graphical interface for monitoring system data from multiple tool-based systems and sensors that monitor and control an injection molding process.

### BACKGROUND OF THE INVENTION

Injection molding systems are becoming more and more complex, incorporating an ever increasing number of separate control systems and sensors. A local operator may need to monitor five or more independent controllers, each restricted to a particular system parameter and utilizing different protocols and display formats.

The problem is further compounded when a customer is running multiple molds in different plants and countries around the world. Each of these molds is a significant investment and the expectation is that the mold will be up and running 24/7 (24 hours a day, 7 days a week). When a mold goes down, the customer's promised delivery dates (i.e., supplying a designated quantity of molded product in a defined time period) cannot be met. One alternative is to stockpile spare molds, an expensive option that still does not eliminate the process time required for setting up a machine with the new mold. Alternatively, one can attempt to shift production to another location, assuming there is another location or machine with spare capacity.

Shifting production and stockpiling molds may be a short term solution to a mold malfunction, but it fails to solve the over-riding problem of monitoring multiple control systems. One approach is to try and unify the control systems at the machine level. While this may be sufficient for a localized (single plant) operation with one set of equipment and an experienced local operator, it does not scale to large numbers of molds and plants around the world, having operators with varying degrees of expertise and disparate equipment and communication systems.

Thus there is a need for more effective monitoring and control of multiple independent systems and sensors utilized in modern injection molding systems across different mold tools, manufacturing plants, and molding processes.

### SUMMARY OF THE INVENTION

In one embodiment of the invention, an apparatus is provided comprising:
a computer-implemented device (80, 90) having a non-transitory computer readable medium with computer executable instructions stored thereon executable by a processor to perform a method of monitoring system data communicated from a plurality of different local tool-based controllers and sensors of a respective injection molding system (IMS), said local tool-based controllers and sensors arranged to monitor and control an injection process of a respective mold tool of the respective IMS, the method including the acts of:
   receiving system data from various ones of the plurality of different local tool-based controllers and sensors of one or more injection molding systems (IMSs), the system data including a local state of one or more system parameters of one or more respective tool-based system functions that are controlled by a respective local tool-based controller, wherein the plurality of different local tool-based controllers include controllers restricted to particular system parameters and utilizing different protocols (8a);
   storing the system data in a storage device (8a);
   receiving as inputs an identification of a user class and an identification of a user access device (8b);
   processing the system data based on the received identification of the user class and the received identification of the user access device to determine a set of available tasks to be implemented by one or more controllers of a selected IMS for at least one of set-up, control, and monitoring of a certain tool-based system function of the selected IMS (8b, 8c);
   directing a display of the determined set of available tasks on a display screen of a graphical user interface (8d);
   receiving and processing user input from a user interface device, the user input including one or more user selected available tasks and one or more related system parameters associated with the selected one or more user selected available tasks for at least one of set-up, control, and monitoring of a set of one or more of the local tool-based controllers (8e); and
   communicating at least some of the received user input toward the set of one or more of local tool-based controllers (8e).

In one embodiment of the invention, the IMS includes an injection molding machine (12), a mold tool (16), and a hot runner system (14), and the local tool-based controllers (40, 46, 53, 54, 56) direct at least some operations of the mold and the hot runner system.

In one embodiment of the invention, the local tool-based controllers include one or more of a hot runner temperature controller (46), a valve pin position controller (40), a mold cavity sensor controller (56), and a mold temperature controller (54).

In one embodiment of the invention, the identification of user class (4) includes one or more of a production operator, a setup operator and a plant manager, and the identification of user access device (5) includes one or more of a local device and a remote device with respect to the local tool-based controller.

In one embodiment of the invention, the method further includes:
receiving, from one or more of the local tool-based controllers, system data indicating an updated local state of the respective local tool-based system function (8a); and
processing the system data indicating the updated local state based on the input identification of the user class and the input identification of the user access device to determine an updated set of available tasks (8b, 8c); and
outputting for display on the display screen of the graphical user interface the determined updated set of available tasks (8d).

In one embodiment of the invention, the method further includes:
remotely monitoring, via the graphical user interface, the local states of the tool-based system functions (6-4, 7-4).

In one embodiment of the invention, the one or more system parameters include one or more of:
a hot runner temperature (92A),
a hot runner pressure (92A),
a valve gate opening (92C),
a valve gate closing (92C),
a mold cavity temperature (92F),
a mold cavity pressure (92F),
a valve pin position (82),
a valve pin speed (82),
a mold cycle (92B);
a mold location (82),
a mold maintenance (92D), and
a part quality (92E).

In one embodiment of the invention, the graphical user interface includes a client application running on a client computing device (90).

In one embodiment of the invention, the display (80, 90) includes a visual representation of one or more system parameters over a period of time.

In one embodiment of the invention, the act of receiving system data (8a) includes receiving system data inputs triggered by detection of system activity by one or more sensors of the injection molding system that monitor one or more of the system parameters.

In one embodiment of the invention, a method is provided to monitor system data received from multiple tool-based controllers and sensors that monitor and control an injection molding process, the method comprising:
receiving system data inputs from various ones of multiple tool-based controllers and sensors, wherein the multiple tool-based controllers and sensors monitor and control system parameters of an injection fluid distribution system, the injection fluid distribution system arranged to receive an injection fluid from an injection molding machine and further arranged to deliver the injection fluid to an injection mold (8a);
receiving as inputs identification of a user class and an identification of a user access device (8b);
generating a set of available tasks to be implemented by the one or more controllers based on the received system data inputs and further based on the identification of the user class and the identification of the user access device (8c);
outputting to a user interface at least some of the set of available tasks for selection by a user (8d);
receiving a user selection of at least one of the at least some of the set of available tasks (8e); and
generating an updated set of available tasks based on the user selection (8b, 8c).

In one embodiment of the invention, the method further comprises:
aggregating the received system data inputs (8a); and
storing the aggregated received system data inputs in a data repository (8a).

In one embodiment of the invention, the set of available tasks includes one or more of production set-up, monitoring production, system parameter updates, and providing inputs to control one or more of the local tool-based controllers.

In one embodiment of the invention, the user selection of at least one of the set of available tasks includes selection of an active object (6-3).

In one embodiment of the invention, outputting to a user interface includes: communicating one or more of: at least some of the set of available tasks, at least some of the updated set of available tasks, and the user selection via a network (8e).

In one embodiment of the invention, a system is provided comprising:
a plurality of different local tool-based controllers (40, 46, 53, 54, 56) and sensors (40A, 40B, 47, 50, 57) of at least one injection molding system (IMS), said local tool-based controllers and sensors arranged to monitor and control an injection process of a respective mold tool (16) of the at least one IMS;
a processor (1010);
a network interface (1040) arranged to pass data between the processor and the plurality of different local tool-based controllers and sensors; and
a non-transitory computer readable medium having executable instructions stored thereon, said executable instructions, when executed by the processor, implement a method of monitoring and controlling an injection molding method, the injection molding method including:
   receiving system data from various ones of the plurality of different local tool-based controllers and sensors of one or more injection molding systems (IMSs), the system data including a local state of one or more system parameters of one or more respective tool-based system functions that are controlled by a respective local tool-based controller, wherein the plurality of different local tool-based controllers include controllers restricted to particular system parameters and utilizing different protocols (8a);
   receiving as an input from a user interface device an identification of a user (8b);
   processing the system data based on the received identification of the user to determine a set of available tasks to be implemented by one or more controllers of a selected IMS (8b, 8c);
   directing a display of the determined set of available tasks on a display screen of a graphical user interface (8d);
   receiving user input from the user interface device, the user input including one or more user selected available tasks and one or more related system parameters associated with the selected one or more user selected available tasks to control a set of one or more of the local tool-based controllers (8e); and
   communicating at least some of the received user input toward the set of one or more of local tool-based controllers (8e).

In one embodiment of the invention, the at least one IMS includes at least two IMS's.

In one embodiment of the invention, the one or more system parameters include one or more of:
a hot runner temperature (92A),
a hot runner pressure (92A),
a valve gate opening (92C),
a valve gate closing (92C),
a mold cavity temperature (92F),
a mold cavity pressure (92F),
a valve pin position (82),
a valve pin speed (82),
a mold cycle (92B);
a mold location (82),
a mold maintenance (92D), and
a part quality (92E).

In one embodiment of the invention, the graphical user interface includes a client application running on a client computing device (90).

In one embodiment of the invention, the system further comprising:
a remote computing device (90) communicatively coupled to the processor (1010) and arranged to provide the user input.

The invention includes all systems and methods as described in this specification and figures.

### BRIEF DESCRIPTION OF THE DRAWINGS

FIG. 1. illustrates schematically a task based navigation system according to one embodiment of the invention, wherein three different factors, namely: system state, user class (type) and user access device, are shown as three defined areas with partially overlapping sectors that define a set of available tasks;

FIGS. 2A and 2B illustrate one example of a design and protocol for the task based navigation system and user interface;

FIG. 3 illustrates a method according to one embodiment of the invention for monitoring system data received from multiple tool-based systems, controllers and sensors and generating a set of available tasks based on system state, user class and user access device, enabling a user to select one of the available tasks for set-up, control, and/or monitoring of one or more of the local tool-based systems, controllers and sensors for a respective injection molding system;

FIG. 4 is a schematic view of one embodiment depicting an injection molding system having multiple local tool-based systems, controllers and sensors and a user interface for use in accordance with one embodiment of the invention;

FIG. 5 is a schematic illustration of one view of a user interface showing multiple graphical content items for selection by the user;

FIG. 6 illustrates an example of a computing device.

### DETAILED DESCRIPTION OF THE INVENTION

### Overview

There will now be described various embodiments of an injection molding task based navigation system for a computer user interface, wherein the navigation system automatically presents the user with a set of tasks that can be performed based on the system state(s) of the injection molding apparatus, the user class (e.g., level or credentials) and the device by which the user has gained access to the navigation system.

Existing computer interfaces for injection molding machines and other sub-systems associated with the injection molding process are based on the user finding the needed tasks from a menu, the menu typically having many drop-down sub-menus and each sub-system having its own set of menus and protocols for selection. As a results, each user spends much of his/her time scrolling through options and data that is neither relevant to a specific task nor of interest to him/her.

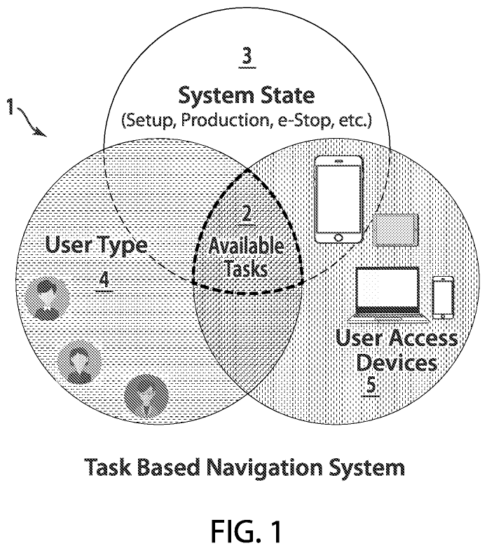

In the task based navigation system of the present invention, the user instead is presented with the available tasks that can be done at the time, wherein the available tasks are limited by the current state of various system parameters for the systems and sub-systems associated with a particular injection molding process or machine, and by the user class and the device by which the user accesses the system. FIG. 1. Illustrates substantially such a task based navigator system (1) wherein three different factors, namely: system state (3), user type (4) and user access device (5), are shown as three defined areas with partially overlapping sectors that define the available tasks (2).

In one embodiment, the task based system classifies the user of a machine, for example, an Injection Molding Machine, according to access rights and requires that the user logs into the system. The access rights for the user can be adjusted depending on the function(s) that need to be performed. As an example, three classes of users may include: a Production Operator, a Setup Operator, and a Plant Manager. Each of these categories of users have specific tasks that they are allowed and/or required to do for set-up, control and/or monitoring of the injection molding process.

In addition, every injection molding system has states which can be defined as a condition which is determined by the various sub-systems. In the case of an Injection Molding Machine, the states could be defined as injection cycle active, stop condition present, safety doors opened, etc.

To complete the inputs required to determine the available tasks, the navigation system also identifies the device from which the user is accessing the system. If the access is via a cell phone, there are certain tasks that by norms of operation cannot be initiated—for example, a particular subsystem may accept user input only from a local user input device located on or near the local system or machine.

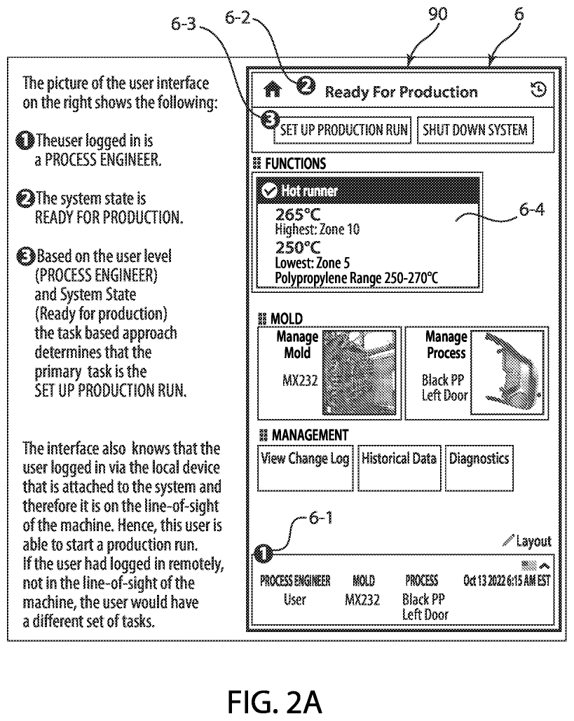

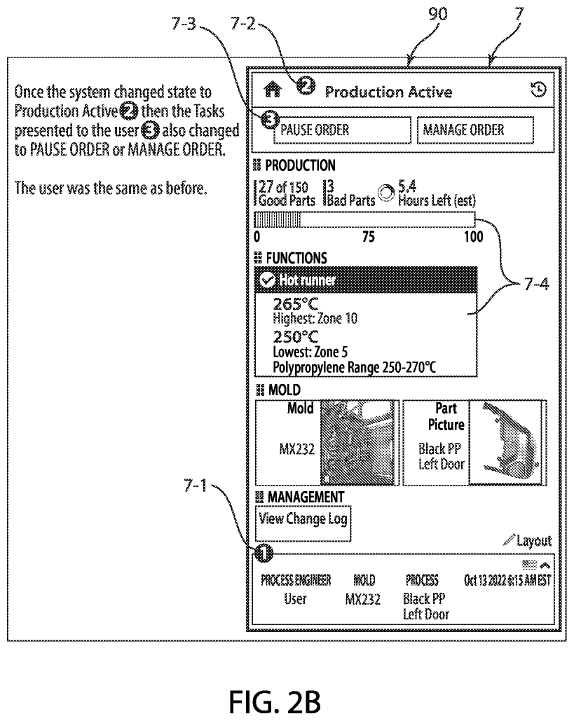

One example of a client computing device (90) having a graphical user interface and display (6, 7) for the task based navigation system is shown in FIGS. 2A and 2B. In FIG. 2A a picture of the user interface (6) on the right shows the following:
1. The user is logged in as a PROCESS ENGINEER (6-1).
2. The system state is READY FOR PRODUCTION (6-2).
3. Based on the User Class (PROCESS ENGINEER) and System State (READY FOR PRODUCTION) the task based approach determines that the primary task is the SET UP PRODUCTION RUN (6-3).

The interface also knows that the user logged in via a local device that is attached to the IMS system and therefore it is in the-line-of-sight of the injection molding machine, IMM. Hence, this user is able to start a production run by directly accessing the IMM local controller. If the user had logged in remotely, not in the-line-of-sight of the injection molding machine, the user would be presented with a different set of tasks.

As shown in FIG. 2B, once the user selects the task SETUP PRODUCTION RUN (6-3) in FIG. 2A, the system display (7) in FIG. 2B changed into Production Active (7-2) and the tasks (7-3) presented to the user on interface (90) also changed to PAUSE ORDER or MANAGE ORDER. The user (7-1) is the same as before (6-1 in FIG. 2A). The dsplay (6, 7) may also include various system data (6-4, 7-4).

As shown, a task based navigation system has advantages over conventional menu driven systems as follows:
The user does not need to search for the tasks to be done as the tasks are presented to the user and not hidden in a menu system.
The interface can be adapted to various types of menu driven systems as long as the user can be identified, the states are clearly defined and the access device can be identified.

By way of example, there are many companies that offer a variety of injection molding control products. For example, Gammaflux provides temperature controllers, Synventive provides activeGate (eGate/eDF, hGate/DF, which may have sensors in the mold and/or hotrunner) controllers, Manner provides e-control for plate actuation and Foboha Cube Mold interface control, Priamus provides FILLcontrol (with sensors in the mold) as well as monitoring solutions. These individual controllers have different protocols and set up parameters and require training for the user to set-up and operate.

In addition, traditional molding machine interfaces have hard-buttons which make it hard to customize for the available tasks.

In one embodiment, a user interface is provided for receiving as system data the local states from the various local tool-based system controllers, processing that system data along with the identification of user class and user access device, and generating a set of available tasks for the user; after selection of one of the available tasks (of the set) by the user, instructions are sent back to the local controllers for implementing the selected task.

In another embodiment, a common control system is provided that combines two or more of the aforementioned system controllers within a single user interface. In this embodiment, it can be even more challenging for the user to set up and use such a common control system with all of the combined available functionality. Therefore, there is a need to provide a simplified user experience by providing a task-based user interface.

As described herein, a task-based user interface navigation system is provided that dynamically changes depending upon the class of user, the type of access device by which the user accesses the navigation system, and the state(s) of the local tool-based controller(s) and/or the tool-based process variable(s) being accessed for use in an injection molding process. By providing the user with a set of the available tasks that can be done at any one time, it reduces the complexity of the solution by eliminating the need to search for the needed tasks.

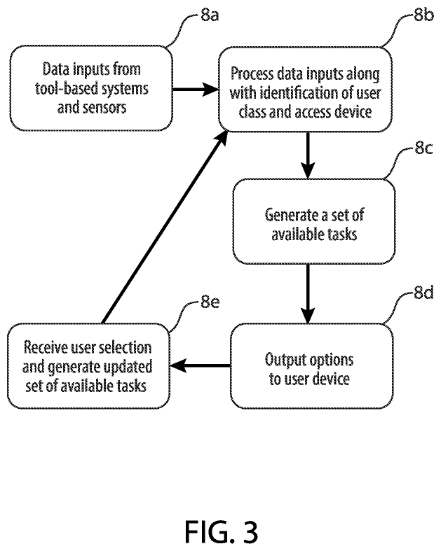

FIG. 3 illustrates one method embodiment of the present invention, wherein the system monitors the tool-based systems and sensors and the user selection to determine a set of available tasks. As illustrated by the flow chart of FIG. 3, the steps of the process are recurring and include:
Data inputs from tool-based system and sensors (8a);
Process data inputs along with identification of user class and access device (8b);
Generate a set of available tasks (8c);
Output options (set of tasks) to user device (8d), as illustrated in FIG. 2A;
Receive user selection (of one task from the set of available tasks) and generate updated set of available tasks for display on user device (8e), as illustrated in FIG. 2B.

Step (8a) may further include: aggregating the received system data inputs;
storing the received system data inputs (or aggregated received system data inputs).

Step (8e) may further include: communicating at least some of the received user selection toward the respective local tool-based controllers.

Step (8b) may further include: receiving system data indicating an updated local state of respective local tool-based system function.

Steps (8c) and (8d) may include: generating for display a set of one or more active objects for selection by the user.

### Technical Effects, Benefits and Examples

The injection molding system and method embodiments with a task based user interface described in the present disclosure provide several technical effects and advances to the field of injection molding system monitoring.

Technical effects and benefits include a task-based navigation system, which has advantages over conventional menu driven systems. One advantage includes, but is not limited to, a user not needing to search for the tasks to be performed as the available tasks are dynamically presented to the user and not hidden in a menu system. Another advantage is that an interface can be adapted to various types of menu driven systems, particularly when a user can be identified, when states are clearly defined, and when an access device can be identified. Still other technical effects and benefits include easier user interface navigation, faster user interface navigation, and more efficient user control of injection molding machines. At least some of these technical effects and benefits are provided when a user is dynamically presented with available tasks limited by the current state of various system parameters for the systems and sub-systems associated with a particular injection molding process or machine rather than being provided with a comprehensive menu of all tasks (i.e., both available and unavailable tasks) rather than just available tasks. One of skill in the art will recognize yet more technical effects and benefits presented in the present disclosure.

The present disclosure sets forth details of various structural embodiments that may be arranged to carry the teaching of the present disclosure. By taking advantage of flexible circuitry, certain mechanical structures, computing architecture, and communications means described herein, a number of exemplary devices and systems are now disclosed.

Example A-1 is an apparatus, comprising: a computer-implemented device having a non-transitory computer readable medium with computer executable instructions stored thereon executable by a processor to perform a method of monitoring system data communicated from a plurality of different local tool-based controllers and sensors of a respective injection molding system (IMS), said local tool-based controllers and sensors arranged to monitor and control an injection process of a respective mold tool of the respective IMS, the method including the acts of: receiving system data from various ones of the plurality of different local tool-based controllers and sensors of one or more injection molding systems (IMSs), the system data including a local state of one or more system parameters of one or more respective tool-based system functions that are controlled by a respective local tool-based controller, wherein the plurality of different local tool-based controllers include controllers restricted to particular system parameters and utilizing different protocols; storing the system data in a storage device; receiving as inputs an identification of a user class and an identification of a user access device; processing the system data based on the received identification of the user class and the received identification of the user access device to determine a set of available tasks to be implemented by one or more controllers of a selected IMS for at least one of set-up, control, and monitoring of a certain tool-based system function of the selected IMS; directing a display of the determined set of available tasks on a display screen of a graphical user interface; receiving and processing user input from a user interface device, the user input including one or more user selected available tasks and one or more related system parameters associated with the selected one or more user selected available tasks for at least one of set-up, control, and monitoring of a set of one or more of the local tool-based controllers; and communicating at least some of the received user input toward the set of one or more of local tool-based controllers.

Example A-2 may include the subject matter of Example A-1, and alternatively or additionally any other example herein, wherein the IMS includes an injection molding machine, a mold tool, and a hot runner system, and the local tool-based controllers direct at least some operations of the mold and the hot runner system.

Example A-3 may include the subject matter of Example A-2, and alternatively or additionally any other example herein, wherein the local tool-based controllers include one or more of a hot runner temperature controller, a valve pin position controller, a mold cavity sensor controller, and a mold temperature controller.

Example A-4 may include the subject matter of any of Examples A-1 to A-3, and alternatively or additionally any other example herein, wherein the identification of user class includes one or more of a production operator, a setup operator and a plant manager, and the identification of user access device includes one or more of a local device and a remote device with respect to the local tool-based controller.

Example A-5 may include the subject matter of any of Examples A-1 to A-4, and alternatively or additionally any other example herein, wherein the method further includes: receiving, from one or more of the local tool-based controllers, system data indicating an updated local state of the respective tool-based system function; and processing the system data indicating the updated local state based on the input identification of the user class and the input identification of the user access device to determine an updated set of available tasks; and outputting for display on the display screen of the graphical user interface the determined updated set of available tasks.

Example A-6 may include the subject matter of any of Examples A-1 to A-5, and alternatively or additionally any other example herein, wherein the method further includes: remotely monitoring, via the graphical user interface, the local states of the tool-based system functions.

Example A-7 may include the subject matter of any of Examples A-1 to A-6, and alternatively or additionally any other example herein, wherein the one or more system parameters include one or more of: a hot runner temperature, a hot runner pressure, a valve gate opening, a valve gate closing, a mold cavity temperature, a mold cavity pressure, a valve pin position, a valve pin speed, a mold cycle; a mold location, a mold maintenance, and a part quality.

Example A-8 may include the subject matter of any of Examples A-1 to A-7, and alternatively or additionally any other example herein, wherein the graphical user interface includes a client application running on a client computing device.

Example A-9 may include the subject matter of any of Examples A-1 to A-8, and alternatively or additionally any other example herein, wherein the display includes a visual representation of one or more system parameters over a period of time.

Example A-10 may include the subject matter of any of Examples A-1 to A-9, and alternatively or additionally any other example herein, wherein the act of receiving system data includes receiving system data inputs triggered by detection of system activity by one or more sensors of the injection molding system that monitor one or more of the system parameters.

Example A-11 may include the subject matter of any of Examples A-1 to A-10, and alternatively or additionally any other example herein, wherein the method further includes: receiving, from the graphical user interface, a user input requesting display of system data relating to one or more user selected tool-based system functions.

Example A-12 may include the subject matter of any of Examples A-1 to A-11, and alternatively or additionally any other example herein, wherein the method further includes: propagating to the graphical user interface at least some of the requested system data.

Example A-13 may include the subject matter of any of Examples A-1 to A-12, and alternatively or additionally any other example herein, wherein the system data includes system data from an injection machine controller of the IMS.

Example A-14 may include the subject matter of any of Examples A-1 to A-13, and alternatively or additionally any other example herein, wherein the computer device and storage device communicate with the controllers and sensors in networked communications, such as cloud-based networked communications.

Example B-1 is a method to monitor system data received from multiple tool-based controllers and sensors that monitor and control an injection molding process, the method comprising: receiving system data inputs from the multiple tool-based controllers and sensors, wherein the multiple tool-based controllers and sensors monitor and control system parameters of an injection fluid distribution system, the injection fluid distribution system arranged to receive an injection fluid from an injection molding machine and further arranged to deliver the injection fluid to an injection mold; receiving as inputs identification of a user class and an identification of a user access device; generating a set of available tasks to be implemented by the one or more controllers based on the received system data inputs and further based on the identification of the user class and the identification of the user access device; outputting to a user interface at least some of the set of available tasks for selection by a user; receiving a user selection of at least one of the at least some of the set of available tasks; and generating an updated set of available tasks based on the user selection.

Example B-2 may include the subject matter of Example B-1, and alternatively or additionally any other example herein, wherein the method further comprises: aggregating the received system data inputs; and storing the aggregated received system data inputs in a data repository.

Example B-3 may include the subject matter of any of Examples B-1 to B-2, and alternatively or additionally any other example herein, wherein the set of available tasks includes one or more of production set-up, monitoring production, system parameter updates, and providing inputs to control one or more of the tool-based controllers.

Example B-4 may include the subject matter of any of Examples B-1 to B-3, and alternatively or additionally any other example herein, wherein the user selection of at least one of the set of available tasks includes selection of an active object.

Example B-5 may include the subject matter of any of Examples B-1 to B-4, and alternatively or additionally any other example herein, wherein the method further comprises: communicating one or more of the at least some of the set of available tasks, at least some of the updated set of available tasks, and the user selection via a network.

Example B-6 may include the subject matter of any of Examples B-1 to B-5, and alternatively or additionally any other example herein, wherein the method further comprises receiving user input from the user interface, the user input related to one or more system parameters; and based on the received user input, generating a further updated the set of available tasks.

Example B-7 may include the subject matter of any of Examples B-1 to B-6, and alternatively or additionally any other example herein, wherein the act of receiving system data inputs from the multiple tool-based controllers and sensors includes receiving system data inputs from multiple tool-based controllers and sensors of multiple injection fluid distribution systems.

Example B-8 may include the subject matter of any of Examples B-1 to B-7, and alternatively or additionally any other example herein, wherein at least some available tasks of the set of available tasks and the updated set of available tasks are displayed on the user interface as user selectable icons.

Example B-9 may include the subject matter of any of Examples B-1 to B-8, and alternatively or additionally any other example herein, wherein the method further comprises receiving from the user interface a request to update one or more of the system parameters.

Example B-10 may include the subject matter of any of Examples B-1 to B-9, and alternatively or additionally any other example herein, wherein the method further comprises receiving from the user interface an updated system parameter.

Example B-11 may include the subject matter of any of Examples B-1 to B-10, and alternatively or additionally any other example herein, wherein the user interface includes a client application running on a client computing device.

Example B-12 may include the subject matter of any of Examples B-1 to B-11, and alternatively or additionally any other example herein, wherein the user interface includes a visual representation of one or more available tasks of the set of available tasks and the updated set of available and a display of one or more system parameters.

Example B-13 may include the subject matter of any of Examples B-1 to B-12, and alternatively or additionally any other example herein, wherein the system data inputs are triggered by detection of system activity by one or more sensors of the injection fluid distribution system.

Example B-14 may include the subject matter of any of Examples B-1 to B-13, and alternatively or additionally any other example herein, wherein the method further comprises receiving from the user interface, a request to store a present state of the active object, and storing the present state in a data repository.

Example B-15 may include the subject matter of any of Examples B-1 to B-14, and alternatively or additionally any other example herein, wherein the method further comprises receiving from the user interface, a request to modify a present state of the active object, generating a modified state of the active object based on the request, and communicating the modified state of the active object toward one or more of the multiple tool-based controllers.

Example B-16 may include the subject matter of any of Examples B-1 to B-15, and alternatively or additionally any other example herein, wherein a non-transitory computer-readable storage medium comprises: instructions stored therein which, when executed by one or more processors, cause the one or more processors to monitor system data and generate the set of available tasks according to the method of Example B-1.

Example C-1 is a system, comprising: a plurality of different local tool-based controllers and sensors of at least one injection molding system (IMS), said local tool-based controllers and sensors arranged to monitor and control an injection process of a respective mold tool of the at least one IMS; a processor; a network interface arranged to pass data between the processor and the plurality of different local tool-based controllers and sensors; and a non-transitory computer readable medium having executable instructions stored thereon, said executable instructions, when executed by the processor, implement a method of monitoring and controlling an injection molding method, the injection molding method including: receiving system data from various ones of the plurality of different local tool-based controllers and sensors of one or more injection molding systems (IMSs), the system data including a local state of one or more system parameters of one or more respective tool-based system functions that are controlled by the respective local tool-based controller, wherein the plurality of local tool-based controllers include controllers restricted to particular system parameters and utilizing different protocols; receiving as an input from a user interface device an identification of a user; processing the system data based on the received identification of the user to determine a set of available tasks to be implemented by one or more controllers of a selected IMS; directing a display of the determined set of available tasks on a display screen of a graphical user interface; receiving user input from the user interface device, the user input including one or more user selected available tasks and one or more related system parameters associated with the selected one or more user selected available tasks to control a set of one or more of the local tool-based controllers; and communicating at least some of the received user input toward the set of one or more of local tool-based controllers.

Example C-2 may include the subject matter of Example C-1, and alternatively or additionally any other example herein, wherein the at least one IMS includes at least two IMS's.

Example C-3 may include the subject matter of any of Examples C-1 to C-2, and alternatively or additionally any other example herein, wherein the one or more system parameters include one or more of: a hot runner temperature, a hot runner pressure, a valve gate opening, a valve gate closing, a mold cavity temperature, a mold cavity pressure, a valve pin position, a valve pin speed, a mold cycle; a mold location, a mold maintenance, and a part quality.

Example C-4 may include the subject matter of any of Examples C-1 to C-3, and alternatively or additionally any other example herein, wherein the graphical user interface includes a client application running on a client computing device.

Example C-5 may include the subject matter of any of Examples C-1 to C-4, and alternatively or additionally any other example herein, wherein the system further comprises: a remote computing device communicatively coupled to the processor and arranged to provide the user input.

Example D-1 is a system, comprising a computer-implemented device for monitoring system data received from a plurality of different local tool-based systems and sensors of a respective injection molding system (IMS) that monitor and control an injection process for a respective mold tool of the IMS, the computer device including program instructions for: receiving system data from the plurality of different local tool-based systems and sensors from one or more injection molding systems (IMSs), the system data a local state of one or more system parameters of a respective local tool-based system function for one or more tool-based systems of a respective IMS; storing the system data, the local states of the tool-based system functions for the local tool-based systems of each of the IMSs in a storage device; receiving as inputs an identification of a user class and an identification of a user access device; processing the system data based on the input identifications of user class and user access device to determine a set of available tasks to be implemented for set-up, control, and/or monitoring of the tool-based system functions of the respective IMS; outputting for display on a display screen of a graphical user interface the determined set of available tasks; receiving and processing user input from the interface device one or more user selected available tasks and one or more system parameters associated with the selected one or more tasks for set-up, control, and/or monitoring of the tool-based system functions of the respective IMS; and transmitting the received one or more system parameters associated with the selected one or more tasks to the respective local-tool-based systems and sensors for set-up, control, and/or monitoring of the respective tool-based system functions.

Example E-1 is a method for monitoring system data received from multiple tool-based systems and sensors that monitor and control an injection molding process, the method comprising: receiving system data inputs from the multiple tool-based systems and sensors, wherein the multiple tool based systems and sensors monitor and control the system parameters of an injection fluid distribution system that receives an injection fluid from an injection molding machine for delivery of the fluid to an injection mold; receiving as inputs identification of a user class and an identification of a user access device; generating a set of available tasks to be implemented by the one or more of the tool-based systems based on the received system data inputs and identification inputs of user class and user access device; outputting to a user interface the available tasks for selection by a user; and receiving a user selection of one of the available tasks and generating an updated set of available tasks based on the user selection.

### Injection Molding System (IMS), Local Controllers and User Interface

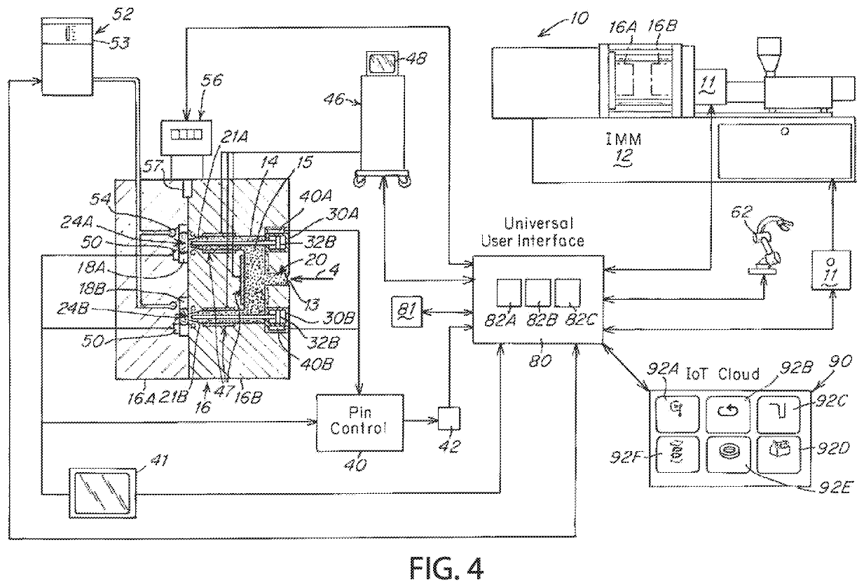

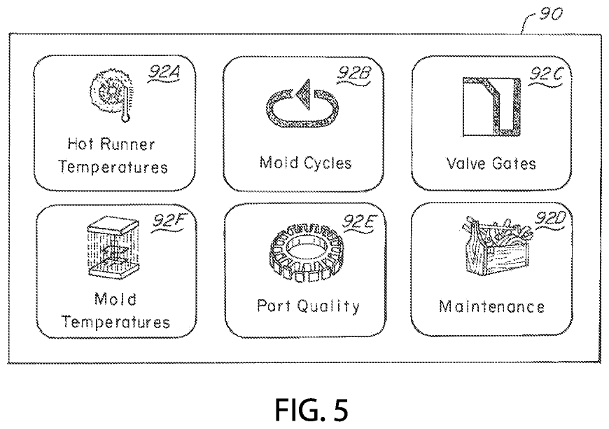

FIGS. 4-5 illustrate one embodiment of an injection molding apparatus and graphical user interface that can be adapted for use in the present invention. FIGS. 4-5 are based on FIGS. 1-2 and the accompanying text from PCT/US2018/033692 entitled Graphical Interface for Injection Molding Systems, published Jan. 17, 2019, by applicant Synventive Molding Solutions Inc.

FIG. 4 is a schematic view of a plastic injection molding apparatus for implementing a common graphical interface that communicates (e.g., in computer networked configuration) with multiple independent local tool-based controllers and sensors that monitor and control an injection molding process according to one embodiment of the invention. The injection molding system (IMS) (10) includes an injection molding machine (12) and a mold tool (16) (also referred to as a mold assembly), the tool (16) typically including a mold (16A, 16B) having one or more mold cavities (18) and a hot runner (14) system that includes a valve gating system (20) including a plurality of nozzles (21) that feed the mold cavities, and an actuator (30) associated with each nozzle. The system further includes multiple controllers and sensors as described further below.

The IMS system illustrated in FIG. 4 includes a plurality of mold cavity sensors (50) that detect a physical properly of the mold or a fluid material in the mold cavity (e.g., temperature or pressure sensors), the sensor output being fed to a local controller (40) and associated display (41) that, together with a local user interface (42) (that accepts input from a human operator) is used to monitor and control the conditions in the tool (16) and/or the fluid material in the mold cavities (18). The cavity sensor output can be used for calculating fluid material viscosity, control loop control and for quality control. The system conditions are further monitored by heaters and thermocouples (TCs) (47), shown here lying adjacent to the nozzles (21) in the tool (16). The heaters and thermocouples are monitored and controlled by a local temperature controller (56) having an associated user interface (display screen and user input device (48)).

The injection molding machine (12) feeds a heated molten fluid material (4) (e.g., a plastic or polymer-based fluid material through a main inlet (13) to a distribution channel (15) of the hot runner (manifold) (14). The distribution channel feeds the fluid material to (in the illustrated embodiment) two separate nozzles (21A and 21B) which in turn respectively feed the fluid material into two separate cavities (18A and 18B) of the tool (16), i.e., each nozzle (21A, 21B) having a respective gate (24A, 24B) that feeds a respective cavity (18A, 18B) of the mold (16). A mold cooling apparatus (52) includes a local mold cooling controller (53) that monitors and controls the delivery of cooling fluid to cooling channels (54) in the mold (16) to regulate the temperature of the mold cavities (18). Another local mold controller (56) monitors and controls opening and closing of the mold halves (16A) and (16B) via a sensor (57) located at the junction of the mold halves.

Each nozzle (21A, 21B) is actuated by an associated actuator (30A, 30B) respectively, wherein each actuator drives an associate valve pin (26A, 26B) in the associated nozzle, the respective valve pin being driven reciprocally along an axial upstream and downstream path of travel through a flow passage in the nozzle, between a downstream gate closed position (GCP) and an upstream gate open position (GOP), and vice versa. Each actuator has a piston (32A, 32B), controlled for example by a solenoid valve, for moving the associated valve pin between the GOP and GCP positions. A position sensor (40A, 40B) detects the position of the piston (32A, 32B) and thus the position of the associated valve pin, between GOP and GCP. The local pin controller (40) monitors and controls the positioning of the valve pins (via actuators 32), as well as the mold cavity conditions via the cavity sensors, such that pin position and cavity temperature can be viewed by the local operator on the local display screen (41). The operator can further input set up parameters and/or adjust the system parameters via the local user interface input device (42).

A computing device comprising a common (universal) graphical interface (80) is provided that communicates with a plurality of the previously described local controllers and sensors. More specifically, the common graphical interface (80) is a computer implemented device for monitoring system data from multiple independent tool based controllers and sensors that monitor and control an injection process. In the present embodiment the interface receives system data from the valve pin controller (40) (which includes data from cavity sensors (50) and valve pin position sensors (40A, 40B), temperature controller (46) (which includes data from the heaters and thermocouples (47)), controller (56) that transmits system data relating to opening and closing of the mold halves (e.g., counting mold cycles) or other mold activity such as tracking the location of a mold, temperature readings, and pressure readings, and mold cooling controller (54) (that includes data relating to the cooling fluid circulated in the cooling channels of the mold tool). The common interface (80) may further receive data from the injection molding machine (12), via the local machine controller (11), that includes a local user interface and display device and transmits data relating to the barrel (e.g., screw position or barrel temperature) and/or the material in the barrel that is being processed and then fed to the inlet (13) to the manifold (14). The common interface may further receive input from a local robot (62) associated with the mold, that picks up the molded parts from the mold cavities for cooling and delivery to other locations. The robot may further include a local controller and/or local user interface. The common interface may store the received data (local state of the various system parameters) in a storage device (81). The individual controllers that communicate with the common graphical interface may or may not have their own local GUI; by providing the common GUI, the local GUI is not necessary.

The common graphical interface (80) has a common graphical user interface (GUI), locally (80) and/or remotely (90), for viewing system parameters of the tool based injection molding system (10), wherein the common graphical interface includes a common set of graphical routines for set up and monitoring of the tool based system functions of the IMS and for providing inputs to the local controllers. The interface includes a display screen, which may be a touch screen, for both displaying and receiving user input to select among the common routines, and/or to select among the various system parameters or common views output on the display screen. The display includes, in one or more portions of the display, graphical content items (82A, 82B, 82C) relating to the system parameters. The system parameters my include one or more of:
hot runner temperature,
hot runner pressure,
valve gate opening or closing,
mold temperature or pressure,
valve pin position or speed,
mold cycle;
mold location,
mold maintenance, and
part quality.
   The common set of graphical routines may include common icons, colors and graphical details. The conunon routines may further include one or more routines to analyze predictive maintenance and preventive maintenance based on the local states of the respective tool based system functions.

In one embodiment, the common graphical interface enables a user (human) to remotely access the interface (80) via a remote computer device (90) (e.g., a client computing device (95), such as desktop computer, a hand-held tablet, or mobile phone as shown in FIGS. 1, 2A and 2B). The remote computing device displays content items (92A-92F) on different regions of the display screen (90) and accepts input (user requests) to the remote computing device for selecting among the common routines, the common views, and the system parameters, in order to view the local state of the various system parameters. It also allows the user to input set up parameters or otherwise provide user input that is then transmitted to the local controllers for controlling the IMS system parameters. FIG. 5 shows a remote client computing device (90), such as the mobile phone illustrated in FIGS. 2A-2B, having a display screen and user input device, and illustrating one common view of the graphical interface with a plurality of content items (92A-92F), namely:
Content item (92A) relating to hot runner temperatures,
Content item (92B) relating to mold cycles,
Content item (92C) relating to valve gates,
Content item (92D) relating to mold tool maintenance,
Content item (92E) relating to molded part quality, and
Content item (92F) relating to mold temperatures.
   The remote access may be via the Internet, or via applications and data stored on the Cloud.

In accordance with one embodiment of the present invention, the remote computer device (90) is a mobile phone as shown in FIGS. 2A-2B having a user display (6,7) for viewing the set of available tasks, along with system data, user class and user access device, and a user input device allowing the user to select one or more of the available tasks. The remote computing device (90) communicates (e.g. wirelessly) with the common user interface (80) for communicating at least some of the user input toward one or more local tool-based controllers. The common user interface may then transmit instructions to the local tool-based controllers in accordance with the selected task and user input, and also receive updated system data from the local tool-based controllers and sensors to process the same and generate an updated set of available tasks (as illustrated by the recurring method steps of FIG. 3).

### Computing Device and Methods

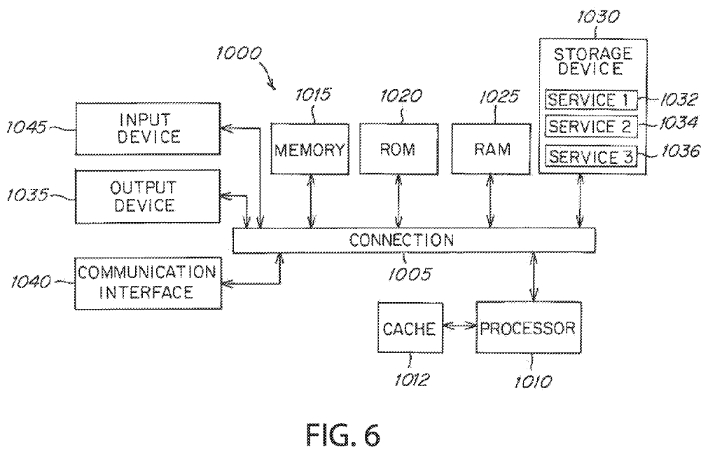

FIG. 6 illustrates an example of a computing device and system architecture (1000) for use in the present invention, namely as the communication interface (80) and/or remote user interface (90), wherein the components of the system (1000) are in communication with each other using a connection (1005). Connection (1005) can be a physical connection via a bus, or direct connection into processor (1010) such as in a chipset architecture. Connection (1005) can also be a virtual connection, networked connection, or logical connection. The connection can be wired or wireless (such as a Bluetooth connection).

In some cases, the system (1000) is a distributed system, wherein the functions described with respect to the components herein can be distributed within a datacenter, multiple datacenters, geographically, etc. In some embodiments, one or more of the described system components represents many such components each performing some or all of the function for which the component is described. In some embodiments, the components described herein can be physical or virtual devices.

Example system (1000) includes at least one processing unit (CPU or processor) (1010) and a connection (1005) that couples various system components including the system memory (1015), such as read only memory (ROM) (1020) and random access memory (RAM) (1025) to the processor (1010). The system (1000) can include a cache of high-speed memory (1012) connected directly with, in close proximity to, or integrated as part of the processor (1010).

The processor (1010) can include any general purpose processor and a hardware service or software service, such as service 1 (1032), service 2 (1034), and service 3 (1036) stored in storage device (1030), configured to control the processor (1010) as well as a special-purpose processor where software instructions are incorporated into the actual processor design. The processor (1010) may essentially be a completely self-contained computing system, containing multiple cores or processors, a bus, memory controller, cache, etc. A multi-core processor may be symmetric or asymmetric.

To enable user interaction with the computing device (1000), an input device (1045) can represent any number of input mechanisms, such as a microphone for speech, a touch-sensitive screen for gesture or graphical input, keyboard, mouse, motion input, speech and so forth. An output device (1035) can also be one or more of a number of output mechanisms known to those of skill in the art. In some instances, multimodal systems can enable a user to provide multiple types of input to communicate with the computing device (1000). The communications interface (1040) can generally govern and manage the user input and system output. There is no restriction on operating on any particular hardware arrangement and therefore the basic features here may easily be substituted for improved hardware or firmware arrangements as they are developed.

Storage device (1030) can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) (1025), read only memory (ROM) (1020), and hybrids thereof.

The storage device (1030) can include code that when executed by the processor (1010), causes the system (1000) to perform a function. A hardware service that performs a particular function can include the software component stored in a computer-readable medium in connection with the hardware components, such as the processor (1010), bus (1005), output device (1035), and so forth, to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. An apparatus, comprising:
a computer-implemented device having a non-transitory computer readable medium with computer executable instructions stored thereon executable by a processor to perform a method of monitoring system data communicated from a plurality of different local tool-based controllers and sensors of a respective injection molding system (IMS), said local tool-based controllers and sensors arranged to monitor and control an injection process of a respective mold tool of the respective IMS, the method including the acts of:
receiving system data from various ones of the plurality of different local tool-based controllers and sensors of one or more injection molding systems (IMSs), the system data including a local state of one or more system parameters of one or more respective tool-based system functions that are controlled by a respective local tool-based controller, wherein the plurality of different local tool-based controllers include controllers restricted to particular system parameters and utilizing different protocols;
storing the system data in a storage device;
receiving as inputs an identification of a user class and an identification of a user access device;
processing the system data based on the received identification of the user class and the received identification of the user access device to determine a set of available tasks to be implemented by one or more controllers of a selected IMS for at least one of set-up, control, and monitoring of a certain tool-based system function of the selected IMS;
directing a display of the determined set of available tasks on a display screen of a graphical user interface;
receiving and processing user input from a user interface device, the user input including one or more user selected available tasks and one or more related system parameters associated with the selected one or more user selected available tasks for at least one of set-up, control, and monitoring of a set of one or more of the local tool-based controllers; and
communicating at least some of the received user input toward the set of one or more of local tool-based controllers.

2. The apparatus of claim 1 wherein the IMS includes an injection molding machine, a mold tool, and a hot runner system, and the local tool-based controllers direct at least some operations of the mold and the hot runner system.

3. The apparatus of claim 1 wherein the local tool-based controllers include one or more of a hot runner temperature controller, a valve pin position controller, a mold cavity sensor controller, and a mold temperature controller.

4. The apparatus of claim 1 wherein the identification of user class includes one or more of a production operator, a setup operator and a plant manager, and the identification of user access device includes one or more of a local device and a remote device with respect to the local tool-based controller.

5. The apparatus of claim 1 wherein the method further includes:
receiving, from one or more of the local tool-based controllers, system data indicating an updated local state of the respective local tool-based system function; and
processing the system data indicating the updated local state based on the input identification of the user class and the input identification of the user access device to determine an updated set of available tasks; and
outputting for display on the display screen of the graphical user interface the determined updated set of available tasks.

6. The apparatus of claim 1 wherein the method further includes:
remotely monitoring, via the graphical user interface, the local states of the tool-based system functions.

7. The apparatus of claim 1 wherein the one or more system parameters include one or more of:
a hot runner temperature,
a hot runner pressure,
a valve gate opening,
a valve gate closing,
a mold cavity temperature,
a mold cavity pressure,
a valve pin position,
a valve pin speed,
a mold cycle;
a mold location,
a mold maintenance, and
a part quality.

8. The apparatus of claim 1 wherein the graphical user interface includes a client application running on a client computing device.

9. The apparatus of claim 1 wherein the display includes a visual representation of one or more system parameters over a period of time.

10. The apparatus of claim 1 wherein the act of receiving system data includes receiving system data inputs triggered by detection of system activity by one or more sensors of the injection molding system that monitor one or more of the system parameters.

11. A method to monitor system data received from multiple tool-based controllers and sensors that monitor and control an injection molding process, the method comprising:
receiving system data inputs from various ones of multiple tool-based controllers and sensors, wherein the multiple tool-based controllers and sensors monitor and control system parameters of an injection fluid distribution system, the injection fluid distribution system arranged to receive an injection fluid from an injection molding machine and further arranged to deliver the injection fluid to an injection mold;
receiving as inputs identification of a user class and an identification of a user access device;
generating a set of available tasks to be implemented by the one or more controllers based on the received system data inputs and further based on the identification of the user class and the identification of the user access device;
outputting to a user interface at least some of the set of available tasks for selection by a user;
receiving a user selection of at least one of the at least some of the set of available tasks; and
generating an updated set of available tasks based on the user selection.

12. The method of claim 11, further comprising:
aggregating the received system data inputs; and
storing the aggregated received system data inputs in a data repository.

13. The method of claim 11, wherein the set of available tasks includes one or more of production set-up, monitoring production, system parameter updates, and providing inputs to control one or more of the local tool-based controllers.

14. The method of claim 11, wherein the user selection of at least one of the set of available tasks includes selection of an active object.

15. The method of claim 13 wherein outputting to a user interface includes:
communicating one or more of: at least some of the set of available tasks, at least some of the updated set of available tasks, and the user selection via a network.

16. A system, comprising:
a plurality of different local tool-based controllers and sensors of at least one injection molding system (IMS), said local tool-based controllers and sensors arranged to monitor and control an injection process of a respective mold tool of the at least one IMS;
a processor;
a network interface arranged to pass data between the processor and the plurality of different local tool-based controllers and sensors; and
a non-transitory computer readable medium having executable instructions stored thereon, said executable instructions, when executed by the processor, implement a method of monitoring and controlling an injection molding method, the injection molding method including:
receiving system data from various ones of the plurality of different local tool-based controllers and sensors of one or more injection molding systems (IMSs), the system data including a local state of one or more system parameters of one or more respective tool-based system functions that are controlled by a respective local tool-based controller, wherein the plurality of different local tool-based controllers include controllers restricted to particular system parameters and utilizing different protocols;
receiving as an input from a user interface device an identification of a user;
processing the system data based on the received identification of the user to determine a set of available tasks to be implemented by one or more controllers of a selected IMS;
directing a display of the determined set of available tasks on a display screen of a graphical user interface;
receiving user input from the user interface device, the user input including one or more user selected available tasks and one or more related system parameters associated with the selected one or more user selected available tasks to control a set of one or more of the local tool-based controllers; and
communicating at least some of the received user input toward the set of one or more of local tool-based controllers.

17. The system of claim 16, wherein the at least one IMS includes at least two IMS's.

18. The system of claim 16, wherein the one or more system parameters include one or more of:
a hot runner temperature,
a hot runner pressure,
a valve gate opening,
a valve gate closing,
a mold cavity temperature,
a mold cavity pressure,
a valve pin position,
a valve pin speed,
a mold cycle;
a mold location,
a mold maintenance, and
a part quality.

19. The system of claim 16 wherein the graphical user interface includes a client application running on a client computing device.

20. The system of claim 16 further comprising:
a remote computing device communicatively coupled to the processor and arranged to provide the user input.
